(19) United States
(12) Patent Application Publication
(10) Pub. No.: US 2008/0013337 A1
(43) Pub. Date: Jan. 17, 2008

(54) BACKLIGHT MODULE AND LIQUID CRYSTAL DISPLAY

(76) Inventor: Chia-Ching Lien, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,202

(22) Filed: Jul. 13, 2006

(51) Int. Cl. F21V 7/04

(52) U.S. Cl. 362/600

(57) ABSTRACT

A backlight module including a back plate, a reflector, a light source and a light guide plate is provided. The back plate has at least a recess. The reflector is disposed on the back plate and has at least one protrusion part disposed on the recess. The light source is disposed on the reflector. The light guide plate is disposed on the back plate and adjacent to the light source, and the light guide plate is supported by the protrusion part. Since the reflector having the protrusion part cooperates with the back plate, the reflector has a larger inner space to avoid the collisions between the light sources, and between the light source and the reflector.

### BACKGROUND OF THE INVENTION

1. Field of the Invention

The present invention generally relates to a display and a light source module, and more particularly, to a liquid crystal display (LCD) and a backlight module.

2. Description of Related Art

With recent advancement in video technology, the LCD has been applied to displays of consumer electronic products such as cell phones, notebook computers, digital cameras and personal digital assistants (PDA) in a great quantity. Besides, because the LCD has the advantages of light weight, compact size and lower power consumption, it has become the mainstream in the market.

The LCD is mainly composed of a backlight module and an LCD panel. The backlight module comprises a light source, a light guide plate and a reflector. In the existing backlight module, the specifications for the thickness of the light guide plate are 6 mm, 8 mm and 10 mm. FIGS. 1A˜1C are schematic cross-sectional views showing different types of conventional backlight modules for illustrating the arrangement of the light source and the reflector corresponding to the light guide plates having different thickness.

Referring to FIG. 1A, the conventional backlight module 100a comprises two light sources 110, a light guide plate 120a and a reflector 130a. The light sources 110 are cathode cold fluorescent lamps (CCFL), and the distance between the centers of the light sources 110 is 3.6 mm. Besides, the thickness of the light guide plate 120a and the inner diameter of the reflector 130a both are 8 mm, and the distance between the center of the light source 110 and the inner wall of the reflector 130a is 2.2 mm. Generally speaking, the diameter of the CCFL is about 2.4 mm. In other words, the distance between the two light sources is 1.2 mm. Similarly, the shortest distance between the light source 110 and the inner wall of the reflector 130a is 1.0 mm. Under the above-mentioned arrangements, either the two light sources 110 or the light source 110 and the reflector 130a would keep a safety distance.

If a thinner light guide plate 120a is used, please refer to FIG. 1B, the backlight module 100b comprises two light sources 110, a light guide plate 120b and a reflector 130b. The thickness of the light guide plate 120b and the inner diameter of the reflector 130b both are 6 mm; the distance between the centers of the light sources 110 is 2.8 mm; the distance between the center of the light source 110 and the inner wall of the reflector 130b is 1.6 mm. Similarly, taking the CCFL whose diameter is 2.4 mm for an example, since the distance between the light sources is only 0.4 mm, the light sources 110 may therefore collide with each other. Further, since the distance between the light source 110 and the inner wall of the reflector 130b is only 0.4 mm, the light source 110 is likely to collide with the reflector 130b. Moreover, since the light sources 110 and the reflector 130b are too close, the brightness of the backlight module 100b is lower than that of the backlight module 100a.

To solve aforementioned problem of the backlight module 100b as shown in FIG. 1B, a reflector having a larger inner diameter may be required to cooperate with the light guide plate 120b. Referring to FIG. 1C, the backlight module 100c comprises two above-mentioned light sources 110, a light guide plate 120b and a reflector 130c. The inner diameter of the reflector 130c is 8 mm. The distance between the centers of the light sources 110 is 3.6 mm, and the distance between the center of the light source 110 and the inner wall of the reflector 130c is 2.2 mm. Taking the CCFL having a diameter of 2.4 mm for an example, the distance between the two light sources 110 is 1.2 mm, and the shortest distance between the light source 110 and the inner wall of the reflector 130c is 1.0 mm. Under the above-mentioned arrangements, the two light sources 110 or the light source 110 and the reflector 130c may not collide with each other. Further, since the inner diameter of the reflector 130c is larger than that of the reflector 130b as shown in FIG. 1B, the brightness of the backlight module 100c is higher than that of the backlight module 100b as shown in FIG. 1B. However, when assembling the backlight module 100c as shown in FIG. 1C, the reflector 130c may be tilted.

### SUMMARY OF THE INVENTION

Accordingly, the present invention is directed to a backlight module, wherein the occurrence of collisions between the light sources, and between the light source and the reflector may be avoided.

The present invention is also directed to an LCD, wherein during the assembling process the reflector may not get tilted.

As embodied and broadly described herein, the present invention provides a backlight module comprising a back plate, a reflector, a light source and a light guide plate. The back plate has at least one recess. The reflector is arranged on the back plate, and the reflector has at least one protrusion part disposed on the recess. The light source is disposed over the reflector. The light guide plate is disposed on the back plate and adjacent to the light source, and the light guide plate is supported by the protrusion part.

According to an embodiment of the present invention, the light guide plate is clipped by the reflector.

According to an embodiment of the present invention, an inner diameter of the reflector is larger than or equal to a thickness of the light guide plate.

According to an embodiment of the present invention, the backlight module further comprises an optical film disposed on the back plate and the protrusion part of the reflector, and under the light guide plate.

According to an embodiment of the present invention, the protrusion part is a rib structure.

As embodied and broadly described herein, the present invention also provides a liquid crystal display comprising a backlight module, a liquid crystal display panel and a front frame. The backlight module comprises a back plate, a reflector, a light source, a light guide plate and a frame. The back plate has at least one recess. The reflector is disposed on the back plate, and the reflector has at least one protrusion part disposed on the recess. The light source is disposed over the reflector. The light guide plate is disposed on the back plate and adjacent to the light source, and the light guide plate is supported by the protrusion part. The frame is arranged on the back plate. The liquid crystal display panel is arranged on the frame of the backlight module. The front frame is assembled with the back plate of the backlight module, to clip the liquid crystal display panel.

According to an embodiment of the present invention, the light guide plate is clipped by the reflector.

According to an embodiment of the present invention, an inner diameter of the reflector is larger than or equal to a thickness of the light guide plate.

According to an embodiment of the present invention, the backlight module further comprises an optical film arranged on the back plate and the protrusion part of the reflector, and under the light guide plate.

According to an embodiment of the present invention, the protrusion part is a rib structure.

In light of the above, a protrusion part is additionally arranged on the reflector of the present invention, and the reflector cooperates with the back plate having the recess to increase the distance between the light sources, and between the light source and the reflector. Therefore, the occurrence of collisions between the light sources, and between the light source and the reflector can be avoided. Besides, since the reflector has the protrusion part, the reflector may not become tilted when assembling the backlight module and thereby improve the assembly convenience.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A˜1C are schematic cross-sectional views showing different types of conventional backlight modules.

FIGS. 2A˜2C are schematic cross-sectional views showing a backlight module according to an embodiment of the present invention, respectively.

FIG. 3 is a schematic cross-sectional view showing an LCD according to an embodiment of the present invention.

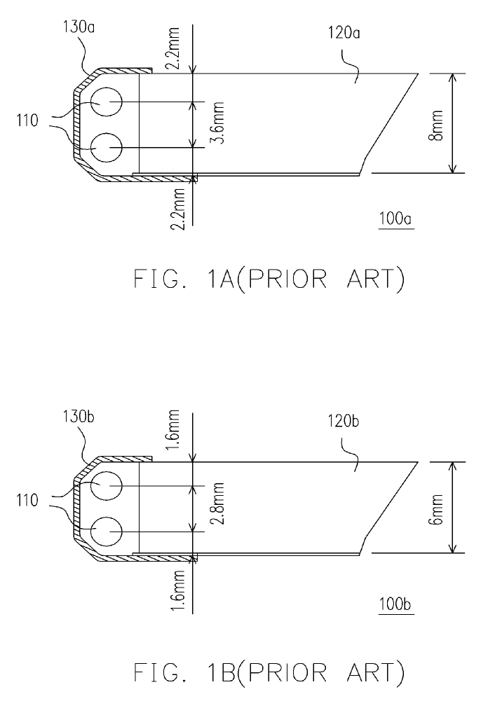

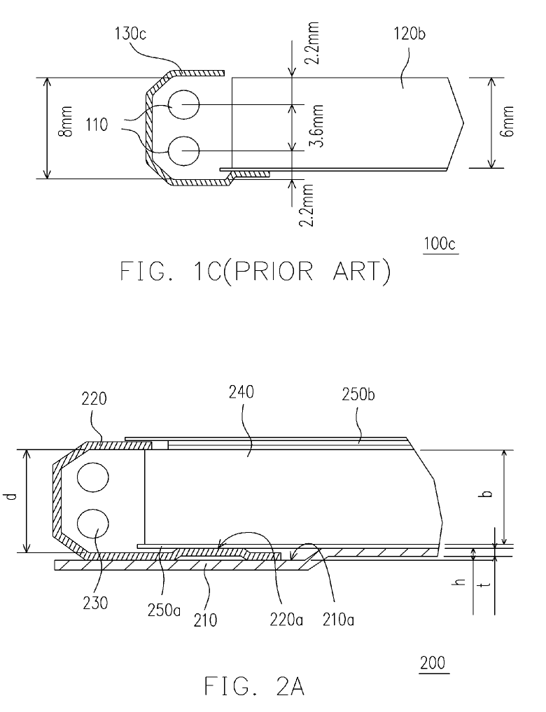

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

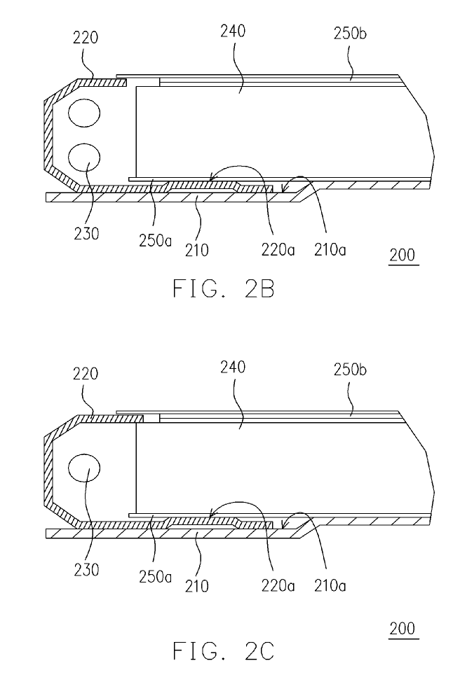

FIGS. 2A˜2C are schematic cross-sectional views showing a backlight module according to an embodiment of the present invention, respectively. Referring to FIG. 2A, the backlight module 200 comprises a back plate 210, a reflector 220, a light source 230 and a light guide plate 240. The back plate 210 may be comprised of aluminium or other suitable metal. The back plate 210 has at least one recess 210a. Generally, the recess 210a is formed by punching, and therefore the height h of the recess 210a depends on the material of the back plate 210. According to this embodiment, the height h of the concave 210a is 1.5 times the thickness t of the back plate 210.

The reflector 220 is arranged on the back plate 210. In this embodiment, the light guide plate 240 is clipped by the reflector 220. However, in another embodiment, the light guide plate 240 may not be clipped by the reflector 220 as shown in FIG. 2B. Besides, the reflector 220 has at least one protrusion part 220a, and the protrusion part 220a is suitable for being arranged within the recess 210a. The protrusion parts 220a may be a rib structure, pillar-shape structure or other suitable structures according to the requirements.

The light source 230 is arranged in the reflector 220, and the light source 230 can be a point light source or a line light source. For example, the light source 230 can be a CCFL or light emitting diodes (LEDs). In this embodiment, two sets of light sources 230 are arranged in the reflector 220. However, there may be only one light source 230 arranged in the reflector 220 as shown in FIG. 2C.

The light guide plate 240 is arranged on the back plate 210 and adjacent to the light source 230. More specifically, the light guide plate 240 is supported by the protrusion part 240a of the reflector 220. In addition, the light emitted by the light source 230 is incident to the light guide plate 240 and then exits the light guide plate 240 from the upper surface thereof, to form a surface light source.

For example, if the thickness b of the light guide plate 240 is 6 mm, the inner diameter of the reflector 220 must be larger than 6 mm in order to prevent the light sources 230 from colliding with each other or prevent the light source 230 and the reflector 220 from colliding with each other. In another embodiment, if the thickness b of the light guide plate 240 is 8 mm, the inner diameter of the reflector 220 may be equal to or larger than 8 mm.

In this embodiment, the backlight module 220 further comprises optical films 250a and 250b, wherein the optical film 250a is disposed on the back plate 210 and the protrusion part 220a of the reflector 220, and under the light guide plate 240. Further, the optical film 250a can be a reflection film. If the protrusion part 220a is closer to the edge of the light guide plate 240, the optical film 250a would not droop. Moreover, the optical film 250b is disposed on the light guide plate 240, wherein the optical film may be a diffusion film or a brightness enhancement film.

Since the reflector 220 has the protrusion part 220a and the back plate 210 has the recess 210a suitable for arranging the protrusion part 220a therein, therefore the reflector 220 of this embodiment has a larger inner space compared to the prior art. In other words, compared to the prior art, the light sources 230 or the light source 230 and the reflector 220 may not collide with each other. Further, since the inner diameter of the reflector 220 is larger than the thickness of the light guide plate 240, therefore, the backlight module 200 of this embodiment has higher brightness compared to the prior art. Moreover, the reflector 220 may either support the light guide plate 240 or may be disposed on the back plate 210 firmly without being tilted due to the protrusion part 220a during assembly, and thereby improve the assembly process. The liquid crystal display (LCD) using the backlight module 200 is illustrated in the following.

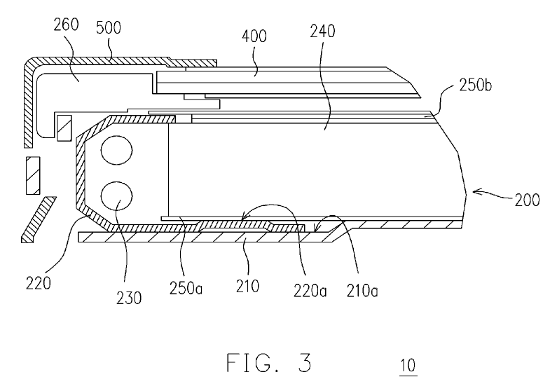

FIG. 3 is a schematic cross-sectional view showing an LCD according to an embodiment of the present invention. Referring to FIG. 3, the LCD 10 comprises the above-mentioned backlight module 200, an LCD panel 400 and a front frame 500. The backlight module 200 further comprises a frame 260 disposed on the back plate 210. Besides, the LCD panel 400 is arranged on the frame 260 of the backlight module 200, and the frame 260 extends towards the above of the light guide plate 240. Further, the front frame 500 is assembled with the back plate 210 of the backlight module 200 to clip the LCD panel 400.

In summary, the LCD and the backlight module of the present invention have at least the following advantages:

1. The present invention employs the reflector having an additional protrusion part to cooperate with the back plate having the recess. Therefore, compared with the prior art, the present invention may adopt a reflector having a larger inner diameter to cooperate with the light guide plate without changing the thickness of the light guide plate and thereby avoid the collision between the light sources or between the light source and the reflector.

2. Because a reflector having a larger inner diameter is employed to cooperate with the light guide plate, the backlight module of the present invention has higher brightness compared to the prior art.

3. An additional protrusion part is formed on the reflector, and therefore the protrusion part may be used to support the light guide plate and prevent the reflector from becoming tilted.

4. Since the protrusion part of the reflector may be closer to the edge of the light guide plate, the optical film between the protrusion part and the light guide plate may not droop.

5. The protrusion part is a portion of the reflector and the recess is also a portion of the back plate, and therefore this would not increase the fabrication cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A backlight module, comprising:
a back plate, having at least a recess;
a reflector, disposed on the back plate, the reflector having at least a protrusion part disposed on the recess;
a light source, disposed on the reflector; and
a light guide plate, disposed on the back plate and adjacent to the light source, and the light guide plate being supported by the protrusion part.

2. The backlight module according to claim 1, wherein the light guide plate is clipped by the reflector.

3. The backlight module according to claim 1, wherein an inner diameter of the reflector is larger than or equal to a thickness of the light guide plate.

4. The backlight module according to claim 1, further comprising an optical film arranged on the back plate and the protrusion part of the reflector, and under the light guide plate.

5. The backlight module according to claim 1, wherein the protrusion part is a rib structure.

6. A liquid crystal display, comprising:
a backlight module, comprising:
a back plate, having at least a recess;
a reflector, disposed on the back plate, the reflector having at least a protrusion part disposed on the recess;
a light source, disposed on the reflector;
a light guide plate, disposed on the back plate and adjacent to the light source, and the light guide plate being supported by the protrusion part;
a frame, disposed on the back plate;
a liquid crystal display panel, disposed on the frame of the backlight module; and
a front frame, assembled with the back plate of the backlight module, to clip the liquid crystal display panel.

7. The liquid crystal display according to claim 6, wherein the light guide plate is clipped by the reflector.

8. The liquid crystal display according to claim 6, wherein an inner diameter of the reflector is larger than or equal to a thickness of the light guide plate.

9. The liquid crystal display according to claim 6, wherein the backlight module further comprises an optical film arranged on the back plate and the protrusion part of the reflector, and under the light guide plate.

10. The liquid crystal display according to claim 6, wherein the protrusion part is a rib structure.
